(19) United States
(12) Patent Application Publication
(10) Pub. No.: US 2013/0305712 A1
(43) Pub. Date: Nov. 21, 2013

(54) ACTUATING DEVICE FOR AN EXHAUST GAS TURBOCHARGER

(71) Applicant: IHI CHARGING SYSTEMS INTERNATIONAL GMBH, Heidelberg (DE)

(72) Inventor: Marc Langohr, Roedersheim (DE)

(73) Assignee: IHI CHARGING SYSTEMS INTERNATIONAL GMBH, Heidelberg (DE)

(21) Appl. No.: 13/952,632

(22) Filed: Jul. 28, 2013

Related U.S. Application Data
(63) Continuation-in-part of application No. PCT/EP2012/000581, filed on Feb. 9, 2012.

(30) Foreign Application Priority Data
Feb. 17, 2011 (DE) 10 2011 011 451.3

(51) Int. Cl. F02B 37/00

(52) U.S. Cl. CPC F02B 37/00
USPC 60/602

(57) ABSTRACT

In an actuating device for an exhaust gas turbocharger for adjusting the charging pressure of the exhaust gas turbocharger, including a valve element which is coupled with an actuating element of the actuating device via at least one intermediate element and which is adjustable via the actuating element between a first position in which a duct of the exhaust gas turbocharger through which exhaust gas may flow is at least partially opened and another position in which the duct is at least partially blocked, the intermediate element which comprises a first end region and a second end region is coupled with the valve element and the actuating element, the intermediate element at its second end region being rotatable about a third axis of rotation relative to the valve element and is coupled with it and at its first end region is rotatable about a second axis of rotation which extends essentially perpendicular to the third axis of rotation relative to the actuating element with which it is also coupled.

This is a Continuation-In-Part application of pending international patent application PCT/EP2012/000581 filed Feb. 9, 2012 and claiming the priority of German patent application 10 2011 011 451.3 filed Feb. 17, 2011.

### BACKGROUND OF THE INVENTION

The invention relates to an actuating device for an exhaust gas turbocharger, in particular for adjusting the charging pressure of the exhaust gas turbocharger.

DE 699 28 331 T2 discloses a turbocharger which comprises a compressor wheel which is arranged within a compressor casing. The compressor casing has a compressed air outlet. A control valve is provided for regulating the pressure of the air supplied from the compressor casing outlet. In addition, a pressure-operated actuating device is provided which is arranged on the turbocharger for actuating the control valve. The actuating device comprises a housing which defines a pressure chamber and an inlet for conveying pressure into the chamber. The housing further comprises a connecting tube which extends from the actuating device inlet to the compressor casing, wherein the end of the connecting tube opposite of the housing is connected to the compressor outlet in order to convey pressure to the actuating device inlet. The connecting tube is essentially rigid and has a pre-defined shape and is integrated with the housing of the actuating device or secured to same so that it constitutes a component of the actuating device before the actuating device is mounted on the turbocharger, wherein a fastening means which is provided for mounting the actuating device housing at the turbocharger is configured such that the operation for mounting of the housing at the turbocharger joins the end of the connecting tube with the compressor outlet.

From US 2003/0196 435 A1 an actuating device for a turbocharger is known which comprises a bypass valve, a shaft as well as a lever arm. The bypass valve is connected with the lever arm via the shaft. The actuating device comprises a lever arm extension which is connected with the lever arm in such a manner that the lever arm extension rotates together with the lever arm corresponding to the movement of the bypass valve. The actuating device further comprises an actuating arm with a first end which is rotatably connected with the lever arm extension. The actuating arm has a second end which comprises a thread and an attachment arm. The attachment arm has a through-hole through which the actuating arm extends. Further, the attachment arm comprises means for fastening it at the turbocharger housing. The actuation capability of the valve element of the known actuating devices is in need of improvement.

It is therefore the principal object of the present invention to provide an actuating device for an exhaust gas turbocharger, in particular for adjusting the charging pressure of the exhaust gas turbocharger, which provides for an improved actuation capability of the valve element.

### SUMMARY OF THE INVENTION

In an actuating device for an exhaust gas turbocharger for adjusting the charging pressure of the exhaust gas turbocharger, including a valve element which is coupled with an actuating element of the actuating device via at least one intermediate element and which is adjustable via the actuating element between a first position in which a duct of the exhaust gas turbocharger through which exhaust gas may flow is at least partially opened and another position in which the duct is at least partially blocked, the intermediate element which comprises a first end region and a second end region is coupled with the valve element and the actuating element, the intermediate element at its second end region being rotatable about a third axis of rotation relative to the valve element and is coupled with it, and at its first end region is rotatable about a second axis of rotation which extends essentially perpendicular to the third axis of rotation relative to the actuating element with which it is also coupled.

Such an actuating device for an exhaust gas turbocharger, in particular for adjusting the charging pressure of the exhaust gas turbocharger, comprises a valve element, which is coupled with an actuating element of the actuating device via at least one intermediate element. The valve element is adjustable via the actuating element between a first position in which a duct of the exhaust gas turbocharger, through which a medium, in particular gas, and in particular, exhaust gas may flow, is at least partially fluidly opened, and at least another position in which the duct is at least partially fluidly blocked. In each case, the intermediate element which comprises a first end region and a second end region is at least indirectly coupled with the valve element and the actuating element.

According to the invention, the intermediate element which is, on the one hand, rotatable at its second end region about a third axis of rotation relative to the valve element, is at least indirectly coupled with it, and is, on the other hand, rotatable at its first end region about a second axis of rotation which extends at least essentially obliquely, in particular perpendicularly, to the third axis of rotation, relative to the actuating element and is at least indirectly coupled with it. Thus, the intermediate element is at least indirectly connected with the valve element in an articulated manner, on the one hand, and, on the other hand, is at least indirectly connected to the actuating element in an articulated manner. By means of these articulated connections, corresponding degrees of freedom for the relative movement of the intermediate element between the valve element and the actuating element are established which result in an improved actuation of the valve element and thereby in an improved functioning of the actuating device. Establishing the degrees of freedom by the articulated connections enables a particularly simple, time and cost efficient assembly of the actuating device, which in turn allows maintaining the total cost of the exhaust gas turbocharger on a moderate level.

The movability of the intermediate element both relative to the valve element about the third axis of rotation and relative to the actuating element about the second axis of rotation which extends obliquely, in particular, perpendicularly, to the third axis of rotation additionally results in very low friction during the operation of the actuating device and results in very low wear of the actuating device. This is accompanied by improved functioning of the inventive actuating device, even over the long life of the exhaust gas turbo-charger. For example, the charging pressure of the exhaust gas turbocharger may be set precisely and defined by means of the inventive actuating device over the long life of the exhaust gas turbocharger, which brings about an efficient operation of the exhaust gas turbocharger and thus an efficient operation of a unit which is assigned to the exhaust gas turbocharger in particular, a combustion engine. Thus, the energy consumption for the operation of the unit may be kept low, which results in low fuel consumption and low CO₂ emission.

Another advantageous aspect of the inventive actuating device is that due to the articulate coupling of the intermediate element both with the valve element and with the actuating element (at least indirectly), actuating forces which occur during the operation of the actuating device are damped, if applicable, without additional damping means and/or damping elements. In addition, the articulate coupling may compensate component and/or assembly-related tolerances, which also contributes favorably to the improved function of the inventive actuating device.

Another advantage of the inventive actuating device is that it is not only particularly easy to assemble but also to disassemble, which in repair cases contributes favorably to time and cost efficient repairs and to time and cost efficient replacements of parts as well.

The inventive actuating device may also advantageously be employed for any exhaust gas turbocharger in order to at least partially open the duct or at least partially block it.

The duct may, for example, be a bypass duct. By means of this bypass duct, exhaust gas may be tapped off upstream of a turbine wheel which is installed at least in portions in the turbine casing of the exhaust gas turbocharger in the flow direction of the exhaust gas and is rotatable about an axis of rotation and can be bypassed to down-stream of the turbine wheel. Thus, the turbine wheel is not hit and not driven by the exhaust gas flowing through the bypass duct, This allows the charging pressure of the exhaust gas turbocharger to be controlled or adjusted.

Preferably, the valve element which is also referred to as wastegate, comprises a position in which the duct, at least essentially, is fluidly blocked so that the medium, in particular the exhaust gas, at least essentially, cannot flow through the duct. In the at least one other position, the valve element at least partially fluidly opens the duct, so that the medium, in particular the exhaust gas, may flow through the duct. In other words, the flow cross-section of the duct is variably adjustable by means of the valve element.

The actuating element is formed, e.g. as a rod or a similar rod element and is movable at least essentially translationally for moving the valve element. For this purpose, the actuating device is provided e.g. with an actuating member, for example a pressure sensor, which is coupled with actuating element and by means of which the actuating element may be moved.

In a particularly advantageous embodiment of the invention, the intermediate element and the actuating element are coupled to each other by means of a plug-and-socket connection. This allows a particularly simple and thus time and cost efficient assembly of the inventive actuating device and keeps the total costs of the inventive actuating device low.

Preferably, the intermediate element forms a socket for the plug-and-socket connection, into which the actuating element is at least partially inserted. Thereby, the costs of the actuating device are kept low, because, in particular, the intermediate element may be machined particularly simply and thus economically so that the socket may be formed particularly advantageously. The socket may also be formed by the actuating element, with the intermediate element at least partially accommodated and inserted in the socket.

By any account, the socket provides for a time and cost efficient insertion of e.g. the actuating element from at least one side. In another embodiment, the socket is formed at least U-shaped or C-shaped and comprises legs defining the socket, which are arranged opposite each other, in particular mutually overlapping, which are connected with each other via a common basic web, with this basic web defining the socket as well Preferably, only one common basic web of the legs is provided, via which the legs are connected with each other. This is advantageous in that e.g. the actuating element may be inserted into the socket in a plurality of plug-in directions and may therefore be articulately connected with the intermediate element in a particularly simple manner.

In another advantageous embodiment of the invention, the intermediate element and the valve element are coupled with each other via a plug-and-socket connection. Thereby, the valve element and the intermediate element may be connected with each in a particularly time and cost efficient manner so that the costs of the inventive actuating device are kept low.

In the plug-and-socket connection of the valve element with the intermediate element, it may advantageously be provided that the intermediate element forms a socket of the plug-and-socket connection, into which the valve element is inserted. The advantage which was already mentioned in relation to the plug-and-socket connection of the intermediate element with the actuating element, namely the particularly simple and time and cost efficient machining of the intermediate element and thus the advantageous configuration of the socket will come into effect.

What was said about the plug-and-socket connection of the actuating element with the intermediate element may analogously be applied to the socket of the plug-and-socket connection between the intermediate element and the valve element. This means that the socket of the plug-and-socket connection between the valve element and the intermediate element may at least essentially be U-shaped or C-shaped and comprises two legs defining the socket, which may be arranged opposite each other, in particular mutually overlapping. The legs are connected in particular via only one common basic web, with the basic web defining the socket as well. This enables a plurality of insertion directions in which e.g. the valve element may be inserted into the socket, so that the connection or coupling, respectively, of the valve elements with the intermediate element may be realized in a particularly time and cost efficient manner.

Preferably, the basic web which connects the legs of the socket of the plug-and-socket connection between the actuating element and the intermediate element is the same basic web design which connects the legs of the socket of the plug-and-socket connection between the valve element and the intermediate element. In other words, only one basic web is provided which connects both the legs of the socket of the plug-and-socket connection between the intermediate element and the actuating element and the legs of the socket of the plug-and-socket connection between the intermediate element and the valve element. The intermediate element therefore requires a very small installation space so that the installation space of the inventive actuating device may be kept small. This is particularly useful for the prevention and/or solution of package problems, in particular in a space-limited area such as an engine compartment of a motor vehicle, in particular, a passenger car.

In an embodiment of the invention, the intermediate element and the valve element are coupled with each other via at least one additional intermediate element which, on the one hand, is coupled with the valve element and, on the other hand, with the intermediate element. The additional intermediate element may be a lever arm which is connected to a shaft which is rotatable about an axis of rotation and is at least indirectly supported on a casing, in particular a turbine casing, of the exhaust gas turbocharger. The valve element is also connected to the shaft for rotation therewith so that the valve element is movable between the at least two positions via the shaft, the additional intermediate element, the intermediate element and the actuating element. This provides for a very compact configuration of the actuating device for an efficient installation, so that the installation space requirement of the entire exhaust gas turbocharger is kept reasonably small. This means, that the valve element is articulately coupled with the first intermediate element via the additional intermediate element, so that the above explanation and what will be described in the following may be applied analogously to the additional intermediate element.

In another advantageous embodiment of the invention, the intermediate element and the valve element and/or the intermediate element and the actuating element are coupled to each other via a connecting element, e.g. a bolt, pin or similar rod element. Thereby, a particularly simple and thus cost efficient assembly as well as a small number of parts of the actuating device is achieved while at the same time its function is improved.

The rod element may e.g. penetrate at least one respective through-hole of the intermediate element and the actuating element and/or of the intermediate element and the valve element and thereby connect the intermediate element with the actuating element and/or the intermediate element with the valve element. The rod element may be a support axle and/or a support shaft, by means of which the articulate coupling, i.e. the coupling which is rotatable about the respective axis of rotation of the intermediate element with the actuating element and/or the intermediate element with the valve element is realized.

In another advantageous embodiment of the invention, the connecting element is secured against movement relative to the intermediate element and the valve element and/or against movement relative to the intermediate element and the actuating element in the axial direction of the bolt, pin or similar rod element by means of at least one locking element, in particular a circlip. This provides for a particularly simple and cost efficient coupling of the valve element and the intermediate element and/or the valve element and the actuating element, while at the same time, a very good function and functional reliability of the actuating device are ensured. The valve element is therefore capable, even over a long life and under high loads, of being reliably actuated and moved by the actuating device.

In a particularly advantageous embodiment of the invention, the intermediate element is integrally formed which reduces the number of parts, the weight and the costs of the inventive actuating device.

In order to limit the range of the angle of rotation of the intermediate element relative to the actuating element, the intermediate element may advantageously be moved between two end positions which limit the range of the angle of rotation, forming a support abutment of the intermediate element at the actuating element. In other words, the intermediate element is rotatable relative to the actuating element about the corresponding axis of rotation only within the limiting range of the angle of rotation and thus by less than 360°. The range of the angle of rotation is, on the one hand, limited by the first end position and, on the other hand, by the second end position into which the intermediate element may be moved, in particular, rotated relative to the actuating element. In the respective end position, a support abutment is formed between the intermediate element and the actuating element, in which the intermediate element at least indirectly abuts the actuating element and cannot move further but merely in the direction of the respective other end position. Thereby, a particularly simple and cost efficient limitation of the range of the angle of rotation is achieved, which again leads to a low number of parts and low costs of the inventive actuating device.

At least one damping element may be provided in order to dampen the abutment when the intermediate element is moved into one of its end positions. The range of the angle of rotation of the intermediate element relative to the actuating element is e.g. 0° to 15°, in particular, the angle of rotation amounts to approx. 2.5°. The intermediate element may therefore move far enough though not undesirably far relative to the actuating element for implementing the described and improved function of the actuating device and the improved actuation of the valve element.

Further advantages, features and details of the invention will become more readily apparent from the following description of a preferred exemplary embodiment thereof with reference to the accompanying drawings. The features and feature combinations as previously mentioned in the description as well as the features and feature combinations illustrated in the figures are not only applicable in the respective indicated combination but also in other combinations or isolated, without deviating from the scope of the invention.

### BRIEF DESCRIPTION OF THE DR WINDS

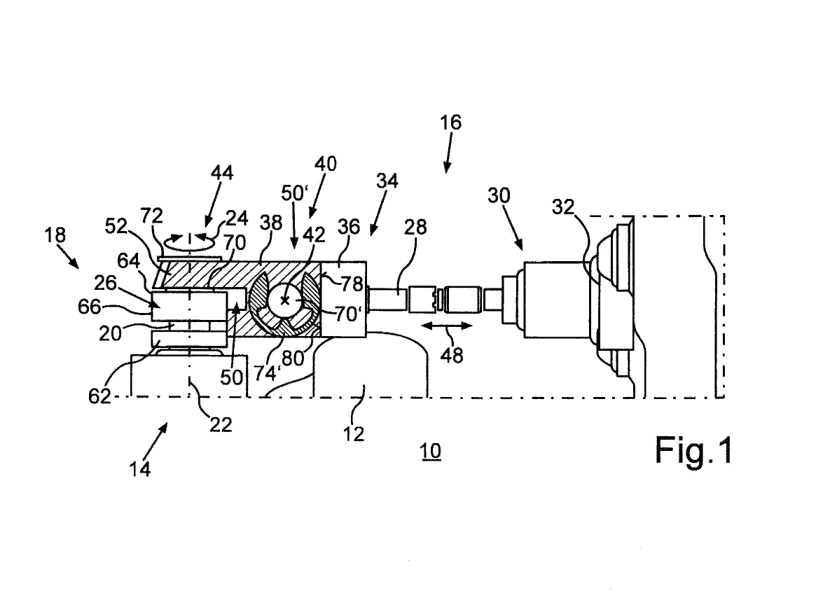

FIG. 1 is a portion of a schematic side view of an exhaust gas turbocharger with an inventive actuating device,

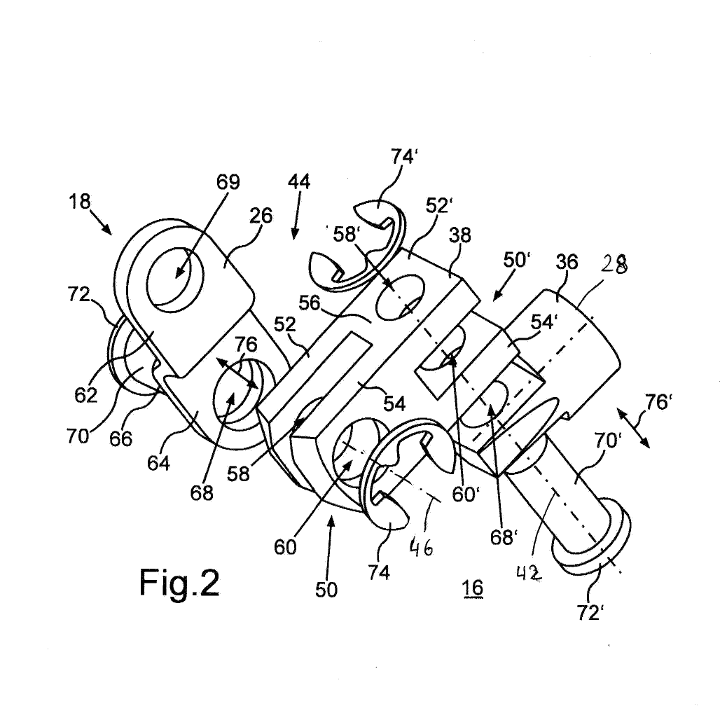

FIG. 2 is a schematic and perspective exploded view of the actuating device according to FIG. 1,

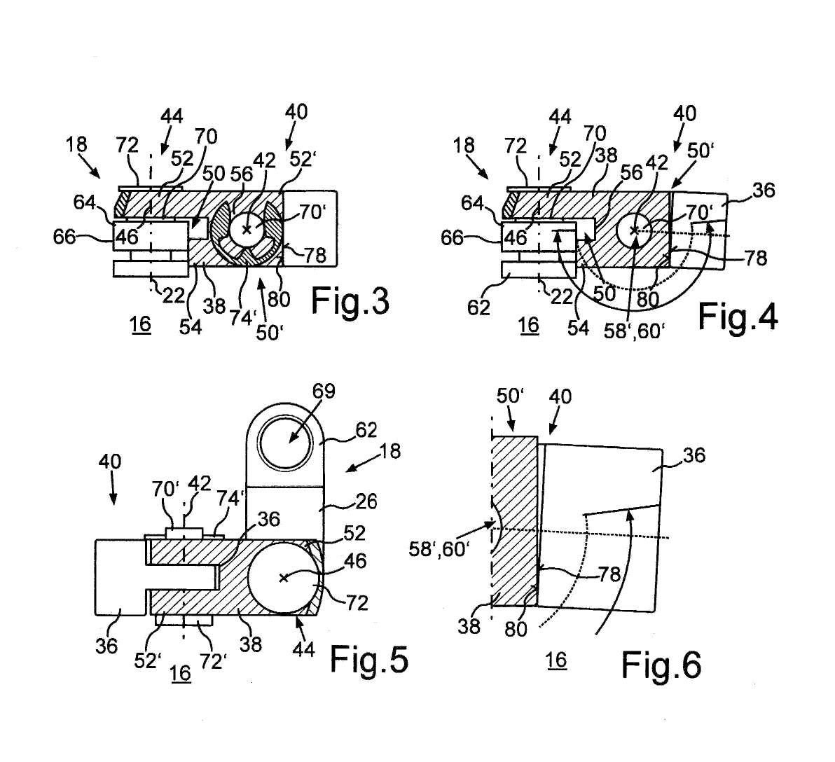

FIG. 3 is a portion of a schematic side view of the actuating device according to FIGS. 1 and 2,

FIG. 4 is a portion of a schematic side view of the actuating device according to FIG. 3, wherein a fork head is moved relative to the actuating rod into a first of two end positions of a range of the angle of rotation,

FIG. 5 is a portion of a schematic and enlarged side view of the actuating device according to FIG. 4, and

FIG. 6 is a schematic plan view of the actuating device according to FIGS. 1 to 5.

### DESCRIPTION OF A PARTICULAR EMBODIMENT

FIG. 1 shows an exhaust gas turbocharger 10 for a combustion engine which, for example, is a reciprocating engine. In FIG. 1, a turbine casing 12 of a turbine 14 of the exhaust gas turbocharger 10 is illustrated, wherein exhaust gas from of the combustion engine may flow though the turbine casing 12. A turbine wheel (not shown in detail) of the turbine 14 is arranged rotatably about an axis of rotation (not shown in detail) in the turbine casing 12, whereby the exhaust gas is supplied to the turbine wheel to hit and drive it. The turbine wheel is connected to a shaft for rotation therewith (not shown in detail) of the exhaust gas turbocharger 10, and also an impeller (not shown in detail) of a compressor (not shown in detail) of the exhaust gas turbocharger 10 is connected to the shaft for rotation therewith. Since the exhaust gas drives the turbine wheel, the impeller is also driven as the shaft is rotated. The air to be supplied to the combustion engine is compressed by means of the impeller. The air is compressed to a so-called charging pressure which is provided by the exhaust gas turbocharger 10.

In order to prevent the charging pressure of the exhaust gas turbocharger 10 from exceeding a threshold value and to thereby adjust the charging pressure, in particular to limit it, the turbine 14 comprises a bypass means (not shown in detail) with at least one bypass duct (not shown in detail) which is, for example, integrated in the turbine casing 12. Exhaust gas may be tapped off by means of the bypass duct in the flow direction of the exhaust gas through the turbine casing 12 upstream of the turbine wheel and may be bypassed to an area downstream of the turbine wheel. The exhaust gas which was tapped off by the bypass duct cannot drive the turbine wheel, This bypass means is referred to as wastegate and makes bypassing of the turbine wheel possible.

This bypassing of the turbine wheel by the exhaust gas via the bypass duct is, however, desired in only a few operating states of the combustion engine. An actuating device 16 is provided for the adequate bypassing of the turbine wheel and thus for the adequate adjustment of the charging pressure of the exhaust gas turbocharger 10. The actuating device 16 comprises a valve element 18 with a valve part (not shown in FIG. 1) which is at least in portions arranged in the bypass duct and is movable between at least two positions. In one of the positions, the bypass duct is fluidly at least essentially blocked by means of the valve part so that no exhaust gas can flow through the bypass duct. In the at least one other of the positions, the bypass duct is, however, at least partially fluidly open so that exhaust gas may flow through the bypass duct while bypassing the turbine wheel.

For actuating and moving the valve part, the valve part is connected for rotation with an adjustment shaft 20 of the valve element 18. The adjustment shaft 20 is rotatable about a first axis of rotation 22 relative to the turbine casing 12 and is at least indirectly supported by the turbine casing. Rotating the adjustment shaft 20 about the first axis of rotation 22, which is indicated e.g. by a directional arrow 24, causes a rotation of the valve part about the first axis of rotation 22 and thus an adjustment of the valve part between the at least two positions. The valve part is preferably adjustable, in particular movable, within an adjustment range between a plurality of different positions, with the valve part preferably being adjustable at least essentially continuously or in steps between the different positions. In this manner, the flow cross-section of the bypass duct through which the tapped off exhaust gas may flow may be variably adjusted.

For adjusting the valve part, a lever element 26 of the valve element 18 is non-rotatably connected with the adjustment shaft 20 of the valve element 18. The lever element 26 may best be seen in FIGS. 2 and 5.

The actuating device 16 further comprises an actuating element 28 formed as an actuating rod which at its first end 30 is coupled with a pressure sensor 32, in particular a vacuum pressure sensor, of the actuating device 16. At its second end 34 opposite the first end 30, the actuating rod 28 has an actuating part 36 via which it is coupled with an intermediate element 38, which is formed as a fork head, of the actuating device 16. The actuating part 36 is, for example, connected with the actuating rod 28 in such a manner that the actuating part 36 comprises a female thread while the actuating rod 28 comprises a corresponding male thread, The actuating part 36 and the actuating rod 28 are screwed together via the female thread and the male thread and are thereby connected. Another type of connection of the actuating part 36 with actuating rod 28 would also be conceivable, e.g. a locked plug-and-socket connection, wherein the actuating rod 28 is inserted into the actuating part 36 or the actuating part 36 is received in the actuating rod 28 and the connection point which is formed between the actuating part 36 and the actuating rod 28 is secured by means of a locking element. In the simplest configuration, a socket pin with corresponding circlips may be used.

At a first end region 40 of the fork head 38, the fork head 38 which is rotatable about a second axis of rotation 42 relative to the actuating rod 28 is coupled with the actuating rod 28. At a second end region 44 opposite the first end region 40, the fork head 38 which is rotatable about a third axis of rotation 46 relative to the lever element 26 is coupled with the valve element 18 and thus connected to the valve element 18. As can best be seen in FIGS. 2 to 5, the second axis of rotation 42 and the third axis of rotation 46 extend at least essentially perpendicular to one another.

Thanks to this articulate coupling of the fork head 38 with the actuating rod 28, on the one hand, and with the valve element 18, on the other hand, the actuating device 16 provides for a particularly simple and thus time and cost efficient assembly as well as for a satisfactory function and functional reliability, because this two-end articulate coupling of the fork head 38 at the first end region 40 and the second end region 44 with the actuating rod 28 and the valve element 18 creates corresponding degrees of freedom which improve the assembly and function of the actuating device 16.

Therefore, the fork head 38 represents an intermediate element via which the valve element 18 may be actuated via the actuating rod 28 by the pressure sensor 32 under low friction and thus low wear. For this purpose, the actuating rod 28 is movable by the pressure sensor 32 at least essentially translationally, as indicated by a directional arrow 48.

As can best be seen in FIG. 2, the fork head 38 and the valve element 18 are connected with each other at the second end region 44 via a plug-and-socket connection. The fork head 38 forms a socket 50 in the second end region 44, which is formed at least essentially C-shaped and comprises two mutually overlapping legs, a first leg 52 and a second leg 54, which are connected via a common web 56. The web 56 too, defines the socket 50. The first leg 52 comprises a first through-hole 58 which is formed in alignment with a second through-hole 60 of the second leg 54.

For coupling the valve element 18 with the fork head, the lever element 26 is inserted in portions into the socket 50. The lever element 26 also comprises two at least essentially parallel legs, that is, a third leg 62 and a fourth leg 64, which are connected with each other via a wall 66 which extends at least essentially perpendicularly with respect to the third leg 62 and the fourth leg 64. This makes the lever element 26 at least essentially Z-shaped.

The third leg 62 comprises a third through-hole 69 which is penetrated by the adjustment shaft 20 and non-rotatably connected with the adjustment shaft 20 via the lever element 26.

The fourth leg 64 comprises a fourth through-hole 68 which corresponds to the first through-hole 58 and the second through-hole 60. When the fourth leg 64 of the lever element 26 is inserted into the socket 50, the first through-hole 58, the second through-hole 60 and the fourth through-hole 68 are arranged at least essentially in alignment with each other. In this condition, a first connecting element 70, which is a connecting pin in this exemplary embodiment, is inserted through the first through-hole 58, the second through-hole 60 and the fourth through-hole 68. The first connecting pin 70 has a first collar 72 at one end, which comes into support abutment with the first leg 52 of the fork head 38, so that the pin 70 is positioned accordingly. In order to prevent the first connecting pin 70, e.g. during operation of the actuating device 16, from moving undesirably out of the first through-hole 58, the second through-hole 60 and the fourth through-hole 68, the first connecting pin 70 is secured by means of a locking element 74, which is in the form of a circlip in this exemplary embodiment. This means in other words that the first connecting pin 70 is secured against an undesired movement in the axial direction (directional arrow 76) of the first connecting pin 70 relative to the lever element 26 and the fork head 38 by means of the first collar 72 and the circlip 74.

For coupling the fork head 38 with the actuating rod 28, an additional socket 50′ is formed in the first end region 40 of the fork head 38, which is at least essentially C-shaped and which comprises additional legs which define the socket 50′, an additional first leg 52′ and an additional second leg 54′. The additional first leg 52′ and the additional second leg 54′ of the additional socket 50′ are connected by a web 56 which connects the additional legs 52′, 54′, which also defines the additional socket 50′. The additional first leg 52′ also comprises an additional first through-hole 58′ which is formed in alignment with an additional second through-hole 60′ of the additional second leg 54′.

For connecting or coupling, respectively, the actuating rod 28 with the fork head 38, the actuating part 36 which is connected with the actuating rod 28 is inserted at least in portions into the additional socket 50′. The actuating part 36 has also an additional fourth through-hole 68′ which in the inserted condition of the actuating part 36 in the additional socket 50′ is arranged at least essentially in alignment with the additional first through-hole 58′ and the additional second through-hole 60′. In this condition, a second connecting element 70′, also in the form of a connecting pin, is inserted through the additional first through-hole 58′, the additional second through-hole 60′ and the additional third through-hole 68′. The second connecting pin 70′ comprises a second collar 72′ which comes in support abutment with the additional second leg 54′ of the fork head 38 after being correspondingly inserted. A second locking element 74′ in the form of a circlip is provided. The second connecting pin 70′ is secured against an undesired relative movement to the fork head 38 and the actuating part 36 in the axial direction of the second connecting pin 70′ by means of the second circlip 74′ and the second collar 72′, with the axial direction being indicated by a directional arrow 76′.

In the assembled condition, the first connecting pin 70 has an axis which is coaxial with the second axis of rotation 42, and the connecting pin 70′ has an axis which is coaxial with the third axis of rotation 46.

The fork head 38 and the actuating part 36 are rotatable relative to each other within a range of the angle of rotation which essentially amounts to at least 2.5°. FIGS. 4 and 6 show a first end position of a relative movement between the fork head 38 and the actuating rod 28 and the actuating part 36, respectively, which is securely connected with the actuating rod 28.

The fork head 38 and the actuating part 36 are positioned in the form of a support abutment. This means that first end faces 78 of the additional first leg 52′ and the additional second leg 54′ are in contact with each other and in abutment with second end faces 80 of the actuating part 36. Thereby a mechanical limitation of the range of the angle of rotation is realized, so that the fork head 38 and the actuating part 36 can move relative to each other, but an undesirably large relative movement is prevented by simple and low-cost means.

From this can be seen that a translationally movement of the actuating rod 28, which is indicated by the directional arrow 48 via the fork head 38 causes a rotational movement of the lever element 26 about the axis of rotation 22. The movable coupling of the fork head 38 with the actuating rod 28 and the valve element 18 compensates component and assembly-related tolerances and enables damping of actuating forces in a cost efficient manner.

What is claimed is:

1. An actuating device (16) for an exhaust gas turbocharger (10), in particular for adjusting the charging pressure of the exhaust gas turbocharger (10), for actuating a valve element (18), which is coupled with an actuating element (28) of the actuating device (16) via an intermediate element (38) and which is adjustable by the actuating element (28) between a first position in which a duct of the exhaust gas turbocharger (10) through which exhaust gas may flow, is at least partially fluidly opened, and at least another position in which the duct is at least partially fluidly blocked, the intermediate element (38) which comprises a first end region (40) and a second end region (44) being at least indirectly coupled with the valve element (18) and the actuating element (28),
the intermediate element (38), at its second end region (44) being rotatable about a third axis of rotation (46) relative to the valve element (18), and being coupled with the valve element (18), and at its first end region (40), being rotatable about a second axis of rotation (42) which extends at an angle with respect to the third axis of rotation (46) relative to the actuating element (28) and is at least indirectly coupled therewith.

2. The actuating device (16) according to claim 1, wherein the intermediate element (38) and the actuating element (28) are coupled with each other via a plug-and-socket connection.

3. The actuating device (16) according to claim 2, wherein an additional socket (50′) of the plug-and-socket connection is formed by the intermediate element (38), into which the actuating element (28) is at least partially inserted.

4. The actuating device (16) according to claim 1, wherein the intermediate element (38) and the valve element (18) are coupled with each other via a plug-and-socket connection.

5. The actuating device (16) according to claim 4, wherein a socket (50) of the plug-and-socket connection is formed by the intermediate element (38), into which the valve element (18) is at least partially inserted.

6. The actuating device (16) according to claim 1, wherein the intermediate element (38) and the valve element (18) and the intermediate element (38) and the actuating element (28) are coupled with each other via connecting elements (70, 70′).

7. The actuating device (16) according to claim 6, wherein the connecting element (70, 70′) is at least essentially secured against a relative movement to the intermediate element (38) and the valve element (18) and against a relative movement with respect to the intermediate element (38) and the actuating element (28) in the axial direction of the connecting element (70, 70′) by means of locking elements (72, 72′, 74, 74′).

8. The actuating device (16) according o claim 1, wherein the intermediate element (38) is in the form of an integral part.

9. The actuating device (16) according to claim 1, wherein the intermediate element (38) and the valve element (18) are coupled with each other via at least one additional intermediate element (26) which, on the one hand, is coupled with the intermediate element (38) and, on the other hand, with the valve element (18).

10. The actuating device (16) according to claim 9, wherein, for limiting the range of the angle of rotation of the intermediate element (38) relative to the actuating element (28), the intermediate element (38) is movable into two end positions each of which limits the range of the angle of rotation and forms a respective support abutment for the intermediate element (38) at the actuating element (28).
